(19) United States
(12) Patent Application Publication
(10) Pub. No.: US 2008/0117355 A1
(43) Pub. Date: May 22, 2008

(54) SURFACE LIGHT SOURCE DEVICE AND LIQUID CRYSTAL DISPLAY DEVICE

(75) Inventor: Akihiro MORI, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/940,592

(22) Filed: Nov. 15, 2007

(30) Foreign Application Priority Data
Nov. 16, 2006 (JP) 2006-309800

(51) Int. Cl. G02F 1/1335; F21V 11/00

(52) U.S. Cl. 349/62; 362/235

(57) ABSTRACT

An object of the present invention is to provide a surface light source device whose brightness can be uniformed and also whose size (including thickness) can be reduced.

A surface light source device according to the present invention comprises a light guidance, and horizontal point light sources. The light guidance has a depression (or hole) within a region to serve as a display region. The horizontal point light sources emit lights having directivity in a substantially parallel direction to a light emitting surface of the light guidance. Further, the horizontal point light sources are arranged in the depression (or hole).

### BACKGROUND OF THE INVENTION

1. Field of the Invention

The present invention relates to a surface light source device, and a liquid crystal display device comprising the surface light source device as a backlight, for example.

2l Description of the Background Art

As a surface light source device using a light guidance, for example, a device having the following configuration already exists.

There exists a surface light source device in which a linear light source such as a CCFL (cold cathode fluorescent lamp) or a point light source such as an LED (light emitting diode) is arranged on the side surface of a light guidance, and lights incident on the light guidance are emitted from the display surface as lights adjusted to a desired luminance distribution by a light diffusing plate provided on the rear surface of the light guidance.

Further, there exists a surface light source device in which a light source is arranged in a depression or a hole formed in a light guidance, and a pattern for light adjustment is provided on the rear surface side and/or the display surface side of the light guidance so that lights adjusted to a desired luminance distribution are emitted from the display surface (Japanese Patent Laid Open No. 10-82915, Japanese Utility Model Laid Open No. 60-163141 (FIG. 1)).

However, in the case of the configuration as thus described where the linear light source or the point light source is arranged on the side surface of the light guidance, the light source is arranged out of a display region. This raises the problem of increased outer shape of the surface light source device.

Further, in the case of arranging the point light source on the side surface of the light guidance (namely, out of the display region), it is difficult to obtain uniform brightness (especially, uniform brightness in the vicinity of the point light source). For obtaining uniform brightness, the need arises to arrange the point light source in a position apart from the display region. However, in the case of arranging the point light source in such a position, the problem of further increased size of the surface light source device occurs.

As opposed to this, the light source is arranged within the display region in the techniques disclosed in Japanese Patent Laid Open No. 10-82915 and Japanese Utility Model Laid Open No. 60-163141. It is therefore possible to make the size of the surface light source device smaller than in the case of arranging the light source out of the display region as described above. However, there is also a problem in the cases of Japanese Patent Laid Open No. 10-82915 and Japanese Utility Model Laid Open No. 60-163141 as shown below.

In the cases of Japanese Patent Laid Open No. 10-82915 and Japanese Utility Model Laid Open No. 60-163141, lights are emitted from the point light source in a perpendicular direction to the display surface. For example, in the cases of Japanese Patent Laid Open No. 10-82915 and Japanese Utility Model Laid Open No. 60-163141, the point light source is arranged such that, when lights from the point light source are diffused and emitted in respective directions, a light with the largest intensity is emitted in the perpendicular direction to the display surface. In Japanese Patent Laid Open No. 10-82915 and Japanese Utility Model Laid Open No. 60-163141 where the point light source is arranged in such a configuration, luminance of a portion directly above the point light source is relatively too high as compared with luminance of other peripheral portions. It is difficult to eliminate the nonuniformity of luminance only by using the light guidance, the light diffusion means, and the like (namely, the problem of the brightness nonuniformity occurs.)

In the cases of the configurations according to Japanese Patent Laid Open No. 10-82915 and Japanese Utility Model Laid Open No. 60-163141, as a method for eliminating the brightness nonuniformity, a method of putting a large distance from the light guidance to the display surface, a method of providing a pattern having a light blocking effect in a portion directly over the light source, and some other methods are considered.

However, in the case of the former elimination method, the thickness of the surface light source device becomes larger, resulting in an increase in size of the surface light source device. In the case of the latter, lights from the light source cannot be effectively used, resulting in a decrease in light utilization efficiency. Therefore, neither method is appropriate.

It is to be noted that in the case of using an LED or the like as the light source, orientation properties of the point light source need to be adjusted from the viewpoint of the brightness uniformity. However, adjustment of the orientation properties of the point light source requires an optical element such as a lens, thereby leading to an increase in size of the surface light source device.

### SUMMARY OF THE INVENTION

It is an object of the present invention to provide a surface light source device whose brightness can be uniformed and also whose size (including thickness) can be reduced, and a liquid crystal display device comprising the surface light source device.

According to the present invention, a surface light source device comprises a light guidance and horizontal point light sources. The light guidance has a depression or a hole in a region to serve as a display region. The horizontal point light sources emit lights having directivity in a substantially parallel direction to a light emitting surface of the light guidance. Further, the horizontal point light sources are arranged in one the depression or one the hole.

Lights emitted from the horizontal point light sources are propagated further throughout the inside of the light guidance. In the surface light source device, the uniformity of brightness can be held all over the display region. Further, the size (including the thickness) of the surface light source device can be reduced.

According to the present invention, a liquid crystal display device comprises a surface light source device, a liquid crystal panel, and a housing. The surface light source device comprises a light guidance and horizontal point light sources. The light guidance has a depression or a hole in a region to serve as a display region. The horizontal point light sources emit lights having directivity in a substantially parallel direction to a light emitting surface of the light guidance. Further, the horizontal point light sources are arranged in one the depression or one the hole. The liquid crystal panel serves as a display section. Moreover, the housing holds the surface light source device and the liquid crystal panel.

Therefore, it is possible to provide a liquid crystal display device whose brightness on a display surface can be uniformed. Further, the size (thickness) of the liquid crystal display device can also be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view showing a configuration of a liquid crystal display device according to Embodiment 1;

FIG. 2 is a view showing a configuration of a light diffusing section formed in a light guidance 4;

FIG. 3 is a view showing a light intensity distribution of a horizontal point light source having directivity;

FIG. 4 is a sectional view showing conditions of propagation of lights emitted from the horizontal point light source inside the light guidance and diffusion of the lights by the light diffusing section;

FIG. 5 is a plan view showing one example of a shape of a depression (or hole) formed in the light guidance;

FIGS. 6 to 9 are sectional views showing other examples of the shape of the depression (or hole) formed in the light guidance;

FIG. 10 is an oblique view showing a condition of arrangement of a plurality of light sources including a perpendicular point light source in a liquid crystal display device (or surface light source device) according to Embodiment 2;

FIG. 11 is a plan view showing a condition of a plurality of perpendicular point light sources being installed;

FIGS. 12 to 15 are views for explaining variations of formation of the depression (or hole).

### DESCRIPTION OF THE PREFERRED EMBODIMENTS

In the following, the present invention is specifically described on the basis of drawings showing its embodiments.

### Embodiment 1

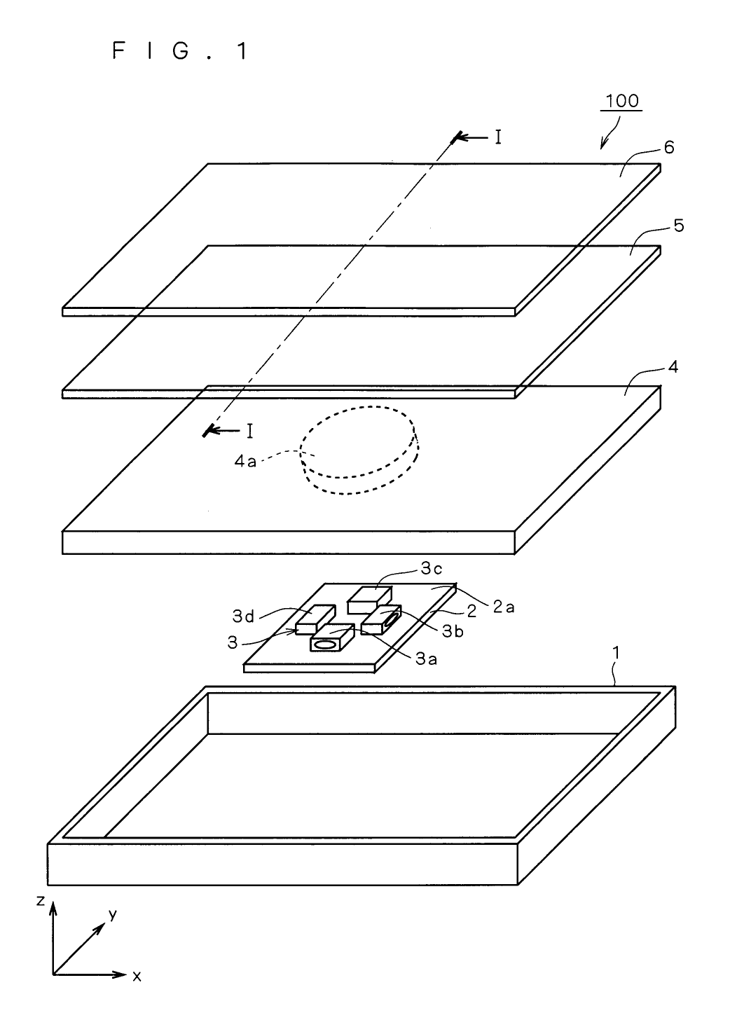

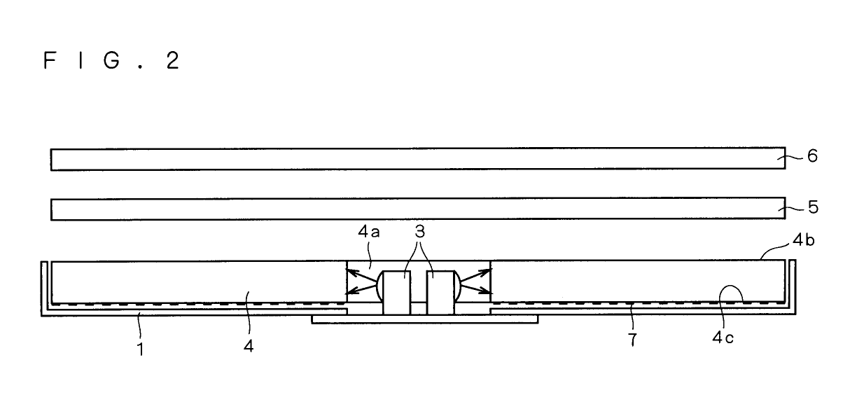

FIG. 1 is an exploded perspective view showing a schematic configuration of a liquid crystal display device including a surface light source device according to the present embodiment. FIG. 2 is a sectional view seen from the direction of arrows I-I in assembly of the surface light source device shown in FIG. 1. FIG. 3 is a view showing a light intensity distribution of a horizontal point light source having directivity. It is to be noted that as shown in FIG. 1, a display region surface is defined as an x-y plane and a direction perpendicular to the display region surface is defined as a z-direction.

As shown in FIG. 1, a liquid crystal display device 100 is made up of a housing 1, a substrate 2, horizontal point light sources 3, a light guidance 4, a light diffusing member 5, and a liquid crystal panel 6. It should be noted that the above listed constituents except for the liquid crystal panel 6 constitute a surface light source device.

Four horizontal point light sources 3, which are first to fourth horizontal point light sources 3 (3a to 3d), are arranged on a first main surface 2a of the substrate 2. Here, the first main surface 2a of the substrate 2 is arranged on the display region surface side (liquid crystal panel arrangement side) in a state where the display device 100 has been assembled. Further, lights emitted from the horizontal point light sources 3 (namely, 3a to 3d) are directed in a substantially parallel direction to the display region surfaces (namely in the substantially parallel direction to the x-y plane), and in respectively different directions. In FIG. 1, lights emitted from the horizontal point light sources 3 (3a to 3d) are directed as follows. Lights from the horizontal point light sources 3b and 3d are directed in the ±x-direction, and lights from the horizontal point light sources 3a and 3c are directed in the ±y-directions. The lights of each pair are directed in substantially opposing directions.

As shown in FIG. 1, the horizontal point light sources 3 are installed in the substantially central part of the display region. As for lights emitted from the first to fourth horizontal point light sources 3a to 3d, with a light emitted from the first horizontal point light source 3a taken as a reference, the lights emitted from the other horizontal point light sources 3 are directed in substantially perpendicular directions (90° and 270°) to the direction of the light taken as the reference (taken as 0°), and a substantially opposing direction (180°) to the direction of the light taken as the reference.

Further, as the horizontal point light source 3, a light source having directivity (e.g. light emitting diode) can be adopted. In a case where the horizontal point light source 3 has directivity, as shown in FIG. 3, when lights are directed in the x-y direction, a position where the horizontal point light source 3 is arranged (“0” point in FIG. 3) has the largest light intensity, and has the peak intensity of lights that are advanced in the x-y directions.

Other than lights directed in the parallel direction to the x-y plane, a light is also emitted in a direction having a certain angle against the x-y plane although having a small intensity. Further, as the direction of this light gets closer to the ±z direction, the intensity of the light is attenuated.

In addition, it is desirable that the horizontal point light source 3 having directivity have a broad light distribution on the x-y plane. With the use of the light source having such a light distribution, lights incident on the light guidance 4 broaden on the x-y plane, thereby making lights emitted from the light emitting surface 4b of the light guidance 4 uniform throughout the light emitting surface 4b.

Further, in the case of using a light source having no directivity, even when lights are diffused and emitted from this light source in respective directions, the lights can be diffused on the x-y plane by arranging the light source such that a light with the largest intensity is directed in the substantially parallel direction to the x-y plane.

As shown in FIG. 1, a depression 4a is formed in the vicinity of the central part within the region to serve as the display region of the light guidance 4. Further, the depression 4a is formed on the main surface on a rear surface 4c side as a surface opposed to the light emitting surface 4b of the light guidance 4.

It should be noted that a hole penetrating the light guidance 4 in the z-direction may be formed in place of the depression 4a. In addition, with the liquid crystal display device 100 in the assembled state, the horizontal point light sources 3 installed on the substrate 2 are housed (arranged) inside the depression (or hole) 4a. Further, the depression (or hole) 4a is provided in the substantial central part of the display region in the light guidance 4 in plan view.

Therefore, as shown in FIG. 1, the horizontal point light sources 3 are arranged at the substantially center of the region to serve as the display region in the assembled state.

Moreover, as shown in FIG. 2, a light diffusing section 7 capable of diffusing lights is formed on the rear surface 4c side of the light guidance 4. The light diffusing section 7 is formed on the light guidance 4 by direct printing or patterning by means of molding or the like. Lights can be diffused and emitted from the light emitting surface 4b of the light guidance 4 by the light diffusing section 7 formed in the light guidance 4 so as to improve the uniformity of brightness of the liquid crystal panel 6. It is to be noted that this light diffusing section 7 may be formed on the light emitting surface 4b side (not shown) rather than on the rear surface 4c side, or may be formed on both the rear surface 4c and the light emitting surface 4b. Moreover, in FIGS. 1 and 2, a light diffusing member 5 formed of a member different from the member for the light guidance 4 is arranged in a position opposed to the light emitting surface 4b of the light guidance 4. The light diffusing member 5 is formed in a plate shape, a sheet shape or a board shape, and has the function of diffusing incident lights. With such a configuration, it is possible to further diffuse lights emitted from the horizontal point light source 3 and emitted from the light guidance 4, so as to obtain uniform brightness.

As seen from FIG. 1, with the liquid crystal display device 100 in the assembled state, the light diffusing member 5, the light guidance 4 and the substrate 2 which has the horizontal point light sources 3 are installed is housed between the housing 1 and the liquid crystal panel 6.

As thus described, the depression (or hole) 4a is formed in the surface light source device (or the liquid crystal display device 100) according to the present embodiment. Further, the foregoing horizontal point light sources 3 are arranged inside the depression (or hole) 4a. Moreover, the light diffusing member 5 capable of diffusing lights emitted from the horizontal point light source 3 is provided.

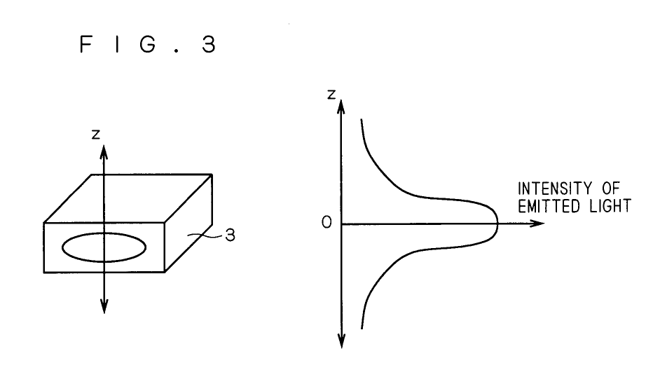

FIG. 4 shows a route map of lights in the surface light source device of the present embodiment. In FIG. 4, lights emitted from the horizontal point light source 3 arranged in the depression 4a of the light guidance 4 are incident from the incident surface that is opposed to the horizontal point light source 3 and forms the depression 4a of the light guidance 4. Lights proceeding to the light diffusing section 7 side which is formed on the rear surface 4c side of the light guidance 4 are dispersed in respective directions by the light diffusing member 5, and emitted from the light emitting surface 4b of the light guidance 4 (L1). Further, lights proceeding to the light emitting surface 4b of the light guidance 4 are all reflected on the light emitting surface 4b, propagated inside the light guidance 4, dispersed in respective directions by the light diffusing member 5, and emitted from the light emitting surface 4b of the light guidance 4 (L2). Hence lights emitted from the horizontal point light source 3 can be sufficiently propagated throughout the inside of the light guidance 4 without local concentration of brightness, and dispersed in respective directions by the light diffusing member 5.

Here, in the present embodiment, the horizontal point light source 3 emits lights having directivity, and the light intensity in the substantially parallel direction to the light emitting surface 4b of the light guidance 4 is large. Therefore, among lights emitted from the horizontal point light source 3, a light in a direction close to the substantially parallel direction to the light emitting surface 4b of the light guidance 4 has the largest light intensity. For this reason, lights emitted from the horizontal point light source 3 and incident on the light guidance 4 can lead to reduction in amount of lights emitted from the light emitting surface 4b of the light guidance 4 immediately after emitted from the light source (lights emitted before sufficiently propagated inside the light guidance 4) and lights not incident on the light guidance 4. Therefore, the light utility efficiency is high, allowing achievement of the brightness uniformity.

As described above, the present embodiment can solve the problem of brightness of the portion directly above the point light source being relatively too high as compared with that of other peripheral portions since the horizontal point light source 3 having the directivity of the x-y plane is arranged in the depression 4a formed in the light guidance 4, the problem having been generated when lights are emitted from the horizontal point light source 3 in the perpendicular direction to the light emitting surface 4b of the light guidance 4. Hence it is possible to hold the brightness uniformity throughout the display region.

Further, the horizontal point light source 3 is installed inside the depression (or hole) 4a formed in the light guidance 4, and also arranged within the display region. This makes it possible to reduce the size (including the thickness) of the surface light source device.

Moreover, in the surface light source device (or the liquid crystal display device 100) according to the present embodiment, the horizontal point light sources 3 are oriented in respective orientations in plan view. It is thus possible to more sufficiently propagate lights inside the light guidance 4.

The number of the horizontal point light sources 3 installed on the substrate 2 are not restricted to four, but may be one or not smaller than two. It is to be noted that even in a case where the number of the horizontal point light sources 3 is not smaller than two, lights emitted from the horizontal point light sources 3 are respectively directed in the substantially parallel directions to the display region (namely in the substantially parallel direction to the x-y plane). Additionally, in this case, lights emitted from the horizontal point light sources 3 are desirably directed in respectively different directions. Further, some of the horizontal point light sources 3 may emit lights in the same direction.

It should be noted that in FIG. 1, the number of the substrates 2 where a plurality of horizontal point light sources 3 are installed is one. Hence the number of the depressions (or holes) 4a formed in the light guidance 4 is also one, the same as the number of the substrate 2. However, in a case where a plurality of substrates 2 exist, the depressions (or holes) 4a may be formed in the light guidance 4 in a plurality of number that is the same as the number of the substrates 2. Here, one substrate 2 is arranged correspondingly inside one depression 4a (a plurality of horizontal point light sources 3 are arranged on the one substrate 2). Further, when a plurality of depressions (or holes) 4a are formed in the light guidance 4, each of the depressions (or holes) 4a is formed within the region to serve as the display region of the light guidance 4. Moreover, even in the case of installing a plurality of horizontal point light sources 3 on one substrate 2, a plurality of depressions (or holes) 4a may be provided and the horizontal point light sources 3 may be installed therein. In this case, since lights are propagated by the light guidance 4 that exists between the horizontal point light sources 3, more uniform brightness can be obtained on the light emitting surface 4b.

It is to be noted that as a material for the foregoing light guidance 4, a transparent resin having favorable optical properties and excellent processing properties (molding properties) is suitable. For example, PMMA, polycarbonate, or the like can be adopted for the light guidance 4.

Further, the shape of the depression (or hole) 4a formed in the light guidance 4 is arbitrarily determined depending upon the number and arrangement of the horizontal point light sources 3 for obtaining a brightness distribution required on the light emitting surface 4b of the light guidance 4.

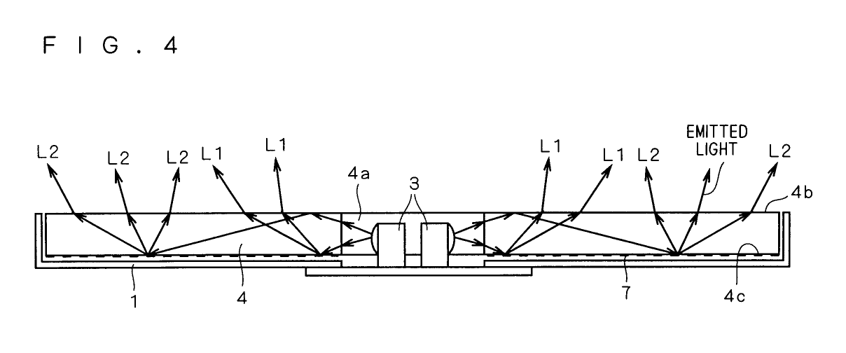

For example, as shown in FIG. 1, the shape of the depression (or hole) 4a in plan view may be circular, or may be oval. Further, as shown in FIG.5, the shape of the depression (or hole) 4a in plan view may be substantially square. Moreover, as shown in FIG. 6, the number of the horizontal point light sources 3 may be more than one, and the shape of the depressions (or holes) 4a in plan view may be rectangular.

Here, as shown in FIG. 6, at least some of the horizontal point light sources 3 respectively emit lights in different directions, and the horizontal point light sources 3 arranged in the long-side direction emit lights in substantially the same direction. It is to be noted that, also in the case shown in FIG. 6, a horizontal point light source 3f is arranged such that, with a light emitted from a horizontal point light source 3e arranged in the short-side direction taken as a reference, lights emitted from other horizontal point light sources are, in plan view, directed in the substantially perpendicular directions or the substantially opposite directions to the direction of the light from the horizontal point light source 3e.

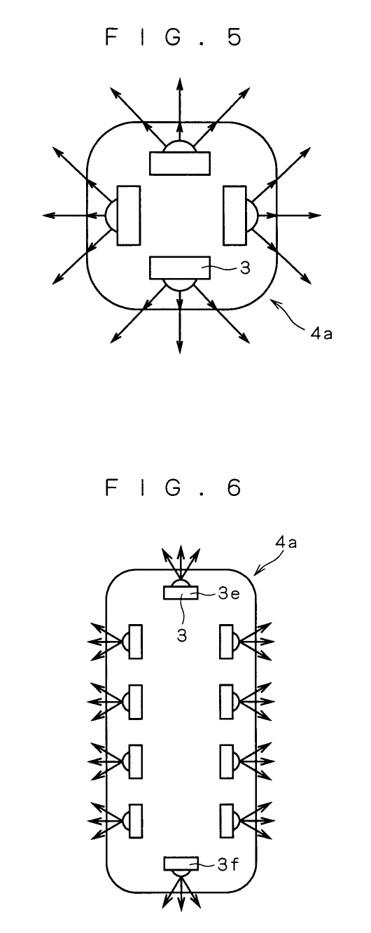

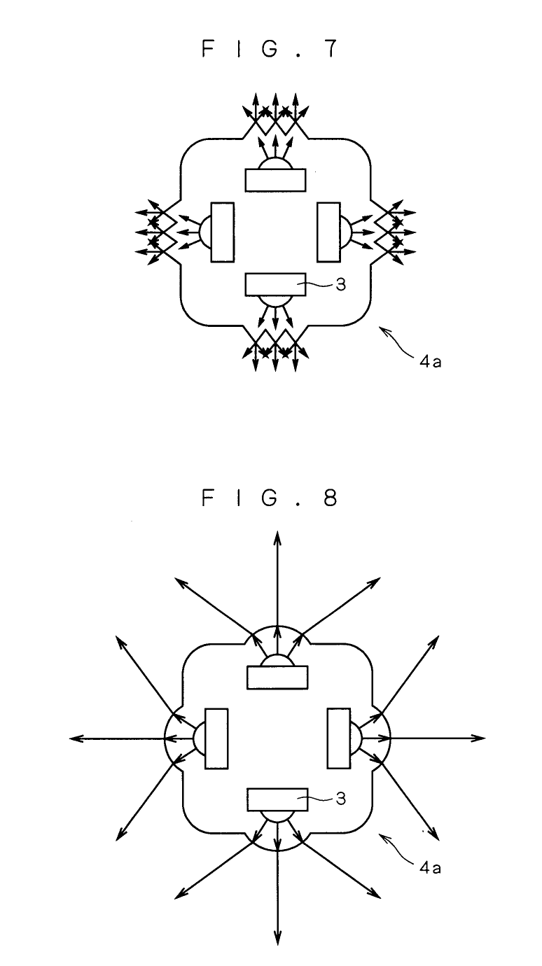

Further, as shown in FIG. 7, the side surface part of the depression (or hole) 4a in a portion facing the horizontal point light sources 3 may have a concavo-convex shape. Thereby, lights emitted from the horizontal point light sources 3 can be dispersed on the side face part so that emitted lights can be propagated further throughout the light guidance 4 (namely, the uniformity of brightness in the display section can be increased.) Further, as shown in FIGS. 8 and 9, the side surface part of the depression (or hole) 4a facing the horizontal point light sources 3 may have a lens shape.

Thereby, within the plane horizontal to the light emitting surface 4b of the light guidance 4, in the case of adopting a lens shape in which incident lights extend when emitted (namely, in the case of using the diffusing effect of a lens) as shown in FIG. 8, lights can be propagated further throughout the light guidance 4 (namely, the uniformity of brightness in the display section can be further increased).

Meanwhile, as shown in FIG. 9, in the case of adopting a lens shape in which incident lights are emitted so as to be aligned in the horizontal direction to the light emitting surface 4b of the light guidance 4 (namely, in the case of using the light focusing effect of a lens), lights emitted from the light emitting surface immediately after emission can be eliminated so that lights in full amount emitted from the horizontal point light source 3 can be propagated further throughout the light guidance 4 (namely, the uniformity of brightness in the display section can be further increased).

It is to be noted that in a case where the hole 4a is not formed but the depression 4a is formed in the light guidance 4, a light diffusing section 7 having a prescribed pattern shape can be formed on top of the depression 4a in the light guidance 4.

It is to be noted that a luminance adjustment function may be added to the light diffusing section 7, the above-mentioned separate member, for achieving a desired luminance distribution within the display surface.

In addition, by adoption of a manufacturing method in which gradation printing is performed or surface roughness is adjusted or a configuration in a fine geometric shape or the like, it is possible to grant the light diffusing section 7 in a prescribed pattern shape formed on the surface of the light guidance 4 and the light diffusing section 7 provided as a separate member from the light guidance 4 with the light diffusing function as well as the luminance adjustment function.

### Embodiment 2

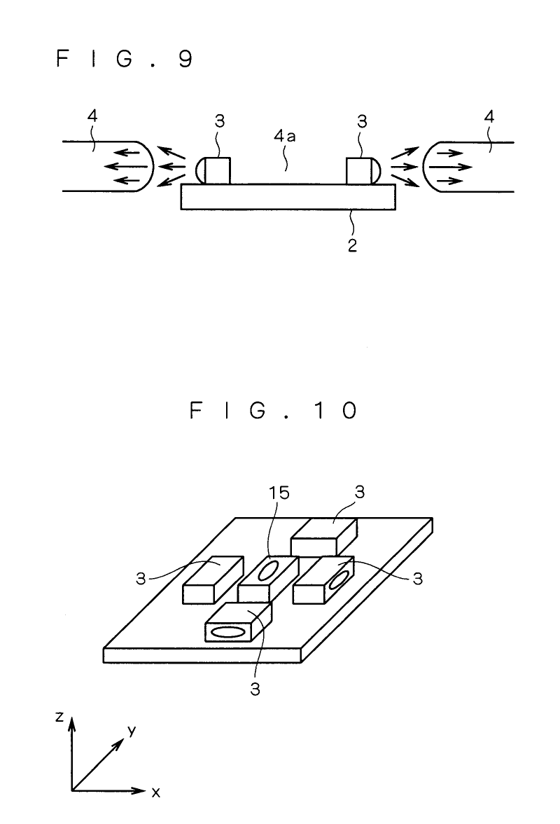

A surface light source device (or liquid crystal display device 100) according to the present embodiment further comprises a perpendicular point light source. Namely, as shown in FIG. 10, a light source 15 which emits lights in one substantially perpendicular direction is installed on the substrate 2 in addition to the plurality of horizontal point light sources 3 described in Embodiment 1. It is to be noted that the action effects are the same as in Embodiment 1 except for an action effect obtained by arrangement of the light source 15 which emits lights in the substantially perpendicular direction.

Here, the coordinate system also put down in FIG. 10 is identical to that in FIG. 1. Therefore, the direction of the display region surface (the direction in which the liquid crystal panel 6 is arranged with respect to the substrate 2) is the +z direction, and the plane horizontal to the display region surface is the x-y plane. Further, also in the present embodiment, the substrate 2 shown in FIG. 10 in the assembled state is arranged inside the depression (or hole) 4a formed in the substantially central part of the light guidance 4. Hence the substrate 2 is located in the substantially central part of the region to serve as the display region in the assembled state.

Lights emitted from the light source 15 which emits lights in the substantially perpendicular direction are directed in substantially perpendicular direction to the display region surface (x-y plane). It is to be noted that the number of the light sources 15 which emit lights in the substantially perpendicular direction installed on the substrate 2 is not restricted to one. For example, the number of the light sources 15 which emit lights in the substantially perpendicular direction can be changed depending upon the shape of the depression (or hole) 4a formed in the light guidance 4, arrangement of the horizontal point light sources 3, or the like, and the number may be not smaller than two.

In Embodiment 2, the arrangement of the light source 15 which emits lights in the substantially perpendicular direction can prevent a decrease in luminance in the vicinity of the center of the depression 4a formed in the light guidance 4. The light source 15 is not particularly restricted so long as being able to obtain an auxiliary light amount, but by arrangement of a light source having weak directivity, uniform brightness can be obtained within the display surface.

As thus described, in the surface light source device (or liquid crystal display device) according to the present embodiment, since the light source 15 which emits lights in the substantially perpendicular direction is provided in addition to the horizontal point light sources 3, a necessary light amount can be secured even in the vicinity of the center of the depression 4a formed in the light guidance 4, shown in FIG. 1 and the like. Hence it is possible to provide further uniform brightness within the display surface.

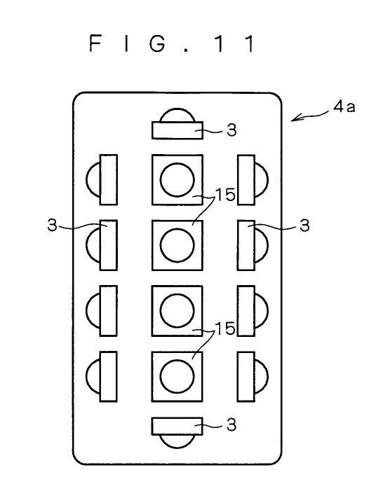

As shown in FIG. 11, the present embodiment is more effective especially when a plurality of light sources 15 which emit lights in the substantially perpendicular direction are installed in a case where the number of alignment of the horizontal point light sources 3 increases and the area of the depression (or hole) 4a in plan view expands.

It is to be noted that the surface light source devices according to the foregoing present embodiments are usable as backlights mainly in monitors for personal computers, liquid crystal display devices and display sections of electronic equipment such as FA (factory automation) devices.

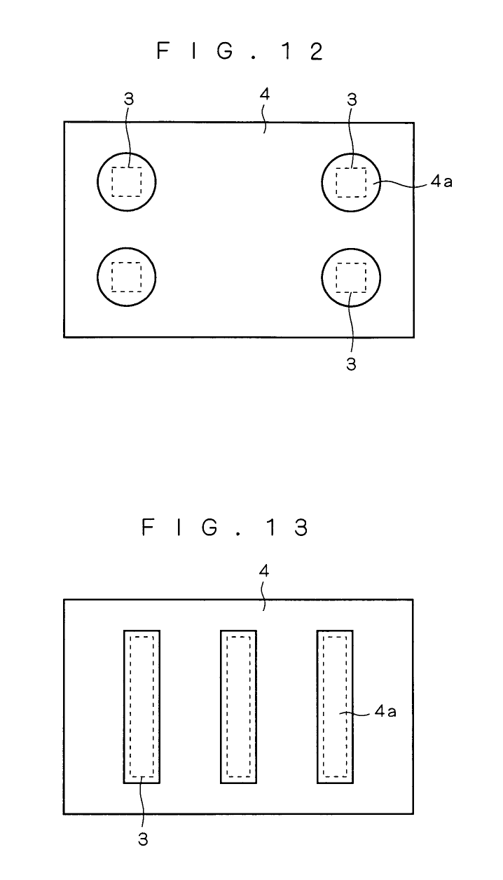

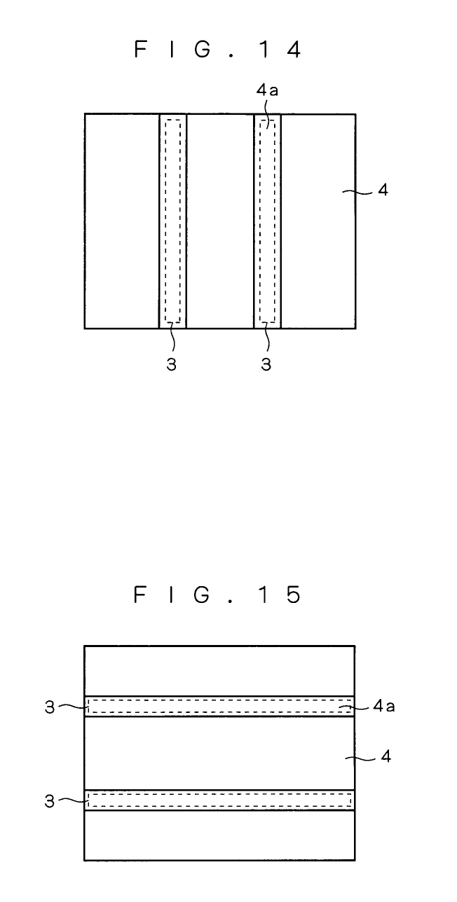

Further, as shown in FIG. 12, the number of depressions (or holes) 4a to be formed in the light guidance 4 may not be one but more than one. For example, as shown in FIG. 12, four circular depressions (or holes) 4a are formed and the horizontal point light source 3 is arranged in each of those depressions (or holes) 4a. Moreover, as shown in FIG. 13, a plurality of rectangular depressions (holes) 4a having short sides and long sides may be formed. Furthermore, as shown in FIGS. 14 and 15, the depressions (or holes) 4a may be formed in a shape having short sides and long sides and penetrating the side surfaces of the light guidance 4 (surfaces other than the light emitting surface 4b and the rear surface 4c). It is to be noted that the depression (or hole) 4a may be formed in a shape having aspects of both FIGS. 14 and 15. The shape and number of the depressions (or holes) 4a can be appropriately changed. In addition, by appropriate arrangement of the horizontal point light sources so as to emit lights in respectively different directions in plan view into the depression (or hole) 4a, it is possible to hold the uniformity of brightness of the entire display region and also provide a surface light source device having high luminance.

While the invention has been shown and described in detail, the foregoing description is in all aspects illustrative and not restrictive. It is therefore understood that numerous modifications and variations can be devised without departing from the scope of the invention.

What is claimed is:

1. A surface light source device, comprising:
a light guidance having a depression or a hole in a region to serve as a display region; and
horizontal point light sources which emit lights having directivity in a substantially parallel direction to a light emitting surface of said light guidance,
wherein plurality ones of said horizontal point light sources are arranged in one said depression or one said hole.

2. The surface light source device according to claim 1, wherein each of said horizontal point light sources emits a light having a peak intensity of emitted lights in said substantially parallel direction.

3. The surface light source device according to claim 2, wherein at least some of said horizontal point light sources emit lights in respectively different directions.

4. The surface light source device according to claim 3, wherein
said depression or hole is provided in the substantially central part of said display region,
said horizontal point light sources at least include first to fourth horizontal point light sources, and
lights emitted from said first to fourth horizontal point light sources are directed, with one light emitted from said horizontal point light source taken as a reference, in two substantially perpendicular directions and an substantially opposite direction to the direction of said light taken as the reference in plan view.

5. The surface light source device according to claim 1, further comprising a light source which emits a light in a substantially perpendicular direction to said light emitting surface of said light guidance.

6. The surface light source device according to claim 1, further comprising a light diffusing section capable of guiding lights emitted from said light emitting surface as diffused lights,
wherein said light diffusing section is provided by processing said light emitting surface of said light guidance and/or a rear surface of said light guidance which is opposed to said light emitting surface.

7. The surface light source device according to claim 1, further comprising a light diffusing member formed of a member different from a member for said light guidance and diffuses lights emitted from said light emitting surface.

8. The surface light source device according to claim 1, wherein said light guidance is PMMA or polycarbonate.

9. The surface light source device according to claim 1, wherein the side surface parts of said depression or the side surface parts of said hole in a portion facing said horizontal point light sources have a concavo-convex shape.

10. The surface light source device according to claim 1, wherein the side surface parts of said depression or the side surface parts of said hole in a portion facing said horizontal point light sources have a lens shape.

11. A liquid crystal display device, comprising:
a surface light source device, including a light guidance which has a depression or a hole in a region to serve as a display region, and horizontal point light sources which emit lights having directivity in a substantially parallel direction to a light emitting surface of said light guidance, plurality ones of said horizontal point light sources being arranged in one said depression or one said hole;
a liquid crystal panel to serve as a display section; and
a housing which holds said surface light source device and said liquid crystal panel.
